(19) United States
(12) Patent Application Publication
(10) Pub. No.: US 2021/0112529 A1
(43) Pub. Date: Apr. 15, 2021

(54) METHODS AND SYSTEMS FOR CONTROL RESOURCE SET AND SEARCH SPACE SET MANAGEMENT

(71) Applicants: AMAN JASSAL, KANATA (CA); JAVAD ABDOLI, KANATA (CA)

(72) Inventors: AMAN JASSAL, KANATA (CA); JAVAD ABDOLI, KANATA (CA)

(73) Assignee: HUAWEI TECHNOLOGIES CO., LTD., SHENZHEN (CN)

(21) Appl. No.: 16/598,216

(22) Filed: Oct. 10, 2019

(51) Int. Cl. H04W 72/04; H04W 76/27

(52) U.S. Cl. CPC H04W 72/042; H04L 1/1812; H04W 72/046; H04W 76/27

(57) ABSTRACT

Systems and methods are provided to improve UE power management and support multiple-PDCCH based multi-TRP or multi-antenna panel transmission with intra-cell (same cell ID) and inter-cell (different Cell IDs). The methods involve configuring CORESETs and associated search space sets. A configured search space set can then be activated implicitly activating the associated CORESET, or a configured CORESET can be activated implicitly activating the associated search space sets. Alternatively, CORESET-search space set links are configured, and then activated. Multiple different overall configurations, each having different CORESET, search space set configurations may be provided and selected between.

### FIELD

This application relates to control resource set and search space set Management in wireless telecommunications systems.

### BACKGROUND

Current solutions for multi-transmit receive point (TRP) management involve supporting the reception of multiple physical downlink control channel (PDCCH) messages over a certain number of control resource sets (CORESETs). As of New Radio (NR) Release 15, a user equipment (UE) can be configured with up to 3 CORESETs per active downlink (DL) bandwidth part (BWP) and 10 search space sets Each search space set (SS) maps to a corresponding CORESET. A UE supports only 1 UE-specific BWP. Up to 4 BWPs can be configured for a UE, but, as mentioned, only 1 BWP can be active at a time. This leads to unnecessary BWP switching delay, reduced flexibility for mixed numerology/services usage, and may introduce dummy physical downlink shared channels (PDSCH), leading to wastage of spectrum, Hybrid Automatic Repeat reQuest (HARQ) resources, and UE processing power.

NR also introduced the BWP concept. DL BWP definition includes PDCCH/PDSCH channel configuration, including CORESETs.

NR Release 16 agreed on supporting multiple PDCCH reception and defining CORESET to TRP correspondence. However, UEs have limited budget for PDCCH blind decoding in a given time-unit (e.g. slot), especially in multi-TRP transmission schemes.

With existing approaches, there is a lack of flexibility in assigning CORESETs and search space sets, and in associating search space sets with CORESETs.

### SUMMARY

Systems are disclosed to improve UE power management and support multiple-PDCCH based multi-TRP or multi-antenna panel transmission with intra-cell (same cell ID) and inter-cell (different Cell IDs); the following radio resource control (RRC) configuration solutions can be used to link multiple PDCCH/PDSCH pairs with multiple TRPs:

a. Having one CORESET in a “PDCCH-config” corresponding to one TRP
b. Increasing the number of CORESETs per “PDCCH-config” to more than 3
c. Implementing UE monitoring/decoding behavior for multiple PDCCHs

According to one aspect of the present disclosure, there is provided a method comprising: transmitting higher-layer signalling to configure a plurality of control resource sets (CORESETs) for a bandwidth part and to configure a plurality search space sets for the bandwidth part; transmitting signalling to activate or deactivate at least one but not all of the configured plurality of CORESETs within the bandwidth; and transmitting at least one control channel message using at least one activated CORESET.

Optionally, transmitting signalling to activate or deactivate at least one but not all of the configured plurality of CORESETs comprises transmitting a bandwidth part identifier identifying the active bandwidth part for which the at least one but not all of the configured plurality of CORESETs is being activated or deactivated.

Optionally, transmitting higher-layer signalling to configure a plurality of control resource sets (CORESETs) and to configure a plurality search space sets comprises: transmitting radio resource control (RRC) signalling.

Optionally, transmitting signalling to activate or deactivate at least one but not all of the configured plurality of CORESETs comprises one of: transmitting a media access control-control entity (MAC-CE); transmitting a downlink control information (DCI); transmitting RRC signalling.

Optionally, the signalling to configure a plurality of control resource sets (CORESETs) and to configure a plurality search space sets configures each search space set in association with a respective one of the configured plurality of control resource sets; transmitting signalling to activate or deactivate at least one but not all of the configured plurality of CORESETs comprises transmitting signalling to explicitly activate or deactivate the at least one search space set, activation or deactivation of a search space set implicitly activating or deactivating the associated CORESET.

Optionally, transmitting signalling to explicitly activate or deactivate the at least one of the configured plurality of search space sets comprises transmitting a message containing a respective field for each of the plurality of search space sets.

Optionally, transmitting a respective field for each of at the one or more search spaces comprises transmitting a bitmap with a respective bit for each configured search space set.

Optionally, the signalling to configure a plurality of control resource sets (CORESETs) and to configure a plurality search space sets configures each search space set in association with a respective one of the configured plurality of CORESETs, such that for each CORESET there is at least one associated search space set; and transmitting signalling to activate or deactivate at least one but not all of the configured plurality of CORESETs comprises transmitting signalling to explicitly activate or deactivate the at least one but not all of the configured CORESETs, activation or deactivation of a CORESET implicitly activating or deactivating the at least one search space set associated with the CORESET.

Optionally, transmitting signalling to explicitly activate or deactivate the at least one of the configured CORESETs comprises transmitting a respective field for each configured CORESETs.

Optionally, transmitting a respective field for each of the plurality of CORESETs comprises transmitting a bitmap with a respective bit for each configured CORESET.

Optionally, transmitting signalling to activate or deactivate at least one but not all of the configured plurality of CORESETs comprises transmitting signalling to explicitly activate or deactivate at least one CORESET-search space set link, each CORESET-search space set link consisting of one CORESET and one search space set.

Optionally, transmitting signalling to explicitly activate or deactivate at least one CORESET-search space set link comprises transmitting a respective field for each of a plurality of possible CORESET-search space set links.

Optionally, transmitting a respective field for each of a plurality of possible CORESET-search space set links comprises transmitting a bitmap with a respective bit for each possible CORESET-search space set link.

Optionally, the method further comprises: performing said transmitting higher-layer signalling to configure a plurality of control resource sets (CORESETs) and to configure a plurality search space sets for each of a plurality of configurations; transmitting signalling to explicitly activate or deactivate one of the plurality of configurations; wherein said signalling to activate or deactivate at least one but not all of the configured plurality of CORESETs is in respect of the activated configuration.

Optionally, transmitting signalling to explicitly activate or deactivate one of the plurality of configurations comprises transmitting a respective field for each of the plurality of configurations.

Optionally, transmitting a respective field for each of the plurality of configurations comprises transmitting a bitmap with a respective bit for of the plurality of configurations.

According to another aspect of the present invention, there is provided a base station comprising: a processor; and a non-transitory computer readable storage medium storing programming for execution by the processor, the programming including instructions to: transmit higher-layer signalling to configure a plurality of control resource sets (CORESETs) for a bandwidth part and to configure a plurality search space sets for the bandwidth part; transmit signalling to activate or deactivate at least one but not all of the configured plurality of CORESETs within the bandwidth; and transmit at least one control channel message using at least one activated CORESET.

Optionally, the instructions to transmit signalling to activate or deactivate at least one but not all of the configured plurality of CORESETs comprise instructions to transmit a bandwidth part identifier identifying the active bandwidth part for which the at least one but not all of the configured plurality of CORESETs is being activated or deactivated.

Optionally, the instructions to transmit higher-layer signalling to configure a plurality of control resource sets (CORESETs) and to configure a plurality search space sets comprise instructions to: transmit radio resource control (RRC) signalling.

Optionally, the instructions to transmit signalling to activate or deactivate at least one but not all of the configured plurality of CORESETs comprises one of: instructions to transmit a media access control-control entity (MAC-CE); instructions to transmit a downlink control information (DCI); instructions to transmit RRC signalling.

Optionally, the signalling to configure a plurality of control resource sets (CORESETs) and to configure a plurality search space sets configures each search space set in association with a respective one of the configured plurality of control resource sets; the instructions to transmit signalling to activate or deactivate at least one but not all of the configured plurality of CORESETs comprises instructions to transmit signalling to explicitly activate or deactivate the at least one search space set, activation or deactivation of a search space set implicitly activating or deactivating the associated CORESET.

Optionally, the signalling to configure a plurality of control resource sets (CORESETs) and to configure a plurality search space sets configures each search space set in association with a respective one of the configured plurality of CORESETs, such that for each CORESET there is at least one associated search space set; and the instructions to transmit signalling to activate or deactivate at least one but not all of the configured plurality of CORESETs comprise instructions to transmit signalling to explicitly activate or deactivate the at least one but not all of the configured CORESETs, activation or deactivation of a CORESET implicitly activating or deactivating the at least one search space set associated with the CORESET.

Optionally, the instructions to transmit signalling to activate or deactivate at least one but not all of the configured plurality of CORESETs comprises instructions to transmit signalling to explicitly activate or deactivate at least one CORESET-search space set link, each CORESET-search space set link consisting of one CORESET and one search space set.

Optionally, the base station further comprises: instructions to performing said transmitting higher-layer signalling to configure a plurality of control resource sets (CORESETs) and to configure a plurality search space sets for each of a plurality of configurations; instructions to transmit signalling to explicitly activate or deactivate one of the plurality of configurations; wherein said signalling to activate or deactivate at least one but not all of the configured plurality of CORESETs is in respect of the activated configuration.

### BRIEF DESCRIPTION OF DRAWINGS

Embodiments of the disclosure will now be described with reference to the attached drawings in which:

FIG. 1 is a flow chart of a method of communication between a network and a UE;

FIG. 2 illustrates a UE signaling configuration;

FIG. 3 illustrates a continuation of the example of FIG. 2;

FIG. 4 illustrates an example activation signaling command;

FIG. 5 illustrates a general form of the activation signaling command;

FIG. 6 is a flow chart of a method of communication between a network and a UE;

FIG. 7 illustrates a UE signaling configuration;

FIG. 8 illustrates a continuation of the example of FIG. 7;

FIG. 9 illustrates an example activation signaling command;

FIG. 10 illustrates a general form of the activation signaling command;

FIG. 11 is a flow chart of a method of communication between a network and a UE;

FIG. 12 illustrates a UE signaling configuration, according to a third embodiment

FIG. 13 illustrates a continuation of the example of FIG. 12;

FIG. 14 illustrates an example activation signaling command;

FIG. 15 illustrates a general form of the activation signaling command;

FIG. 16 is a flow chart of another method of communication between a network and a UE;

FIG. 17 illustrates a UE signaling configuration;

FIG. 18 illustrates a continuation of the example of FIG. 17;

FIG. 19 illustrates an example activation signaling command;

FIG. 20 illustrates a general form of the activation signaling command;

FIG. 21 is a network diagram of a communication system;

FIG. 22A is a block diagram of an example electronic device; and

FIG. 22B is a block diagram of an example electronic device.

### DETAILED DESCRIPTION OF EMBODIMENTS

Generally, embodiments of the present disclosure provide a method and system for managing mobility between Transmit receive points (TRPs) that can belong to the same or different cells without involving higher-layer reconfiguration, thus reducing power consumption at the user equipment (UE) side. For simplicity and clarity of illustration, reference numerals may be repeated among the figures to indicate corresponding or analogous elements. Numerous details are set forth to provide an understanding of the examples described herein. The examples may be practiced without these details. In other instances, well-known methods, procedures, and components are not described in detail to avoid obscuring the examples described. The description is not to be considered as limited to the scope of the examples described herein.

UEs typically have limited budget for physical downlink control channel (PDCCH) blind decodings in a given time-unit (e.g. slot). As a result, PDCCH blind decoding budget management may be a problem for UEs, in particular in multi-TRP systems. There is currently no mechanism in new radio (NR) to control UE power consumption by adding/releasing control resource sets (CORESETs) or search space sets (SS) (also referred to as search spaces) dynamically or semi-statically.

The introduction of activation/deactivation of CORESETs and search space sets at the UE allows the network to manage UE power consumption through PDCCH blind decoding management. Dynamic management of CORESETs and search space sets allows the network to manage mobility between TRPs in a seam-less manner. A CORESET is a specific set of physical resource blocks used to receive control channel transmissions. A search space set defines a set of rules to apply, including how to look for control channel messages on a given CORESET. Example search filters include specific or ranges of frequencies, types of messaging formats (e.g. different DCI formats), the periodicity/time frames of transmissions, size of blocks, and location of blocks within a given CORESET.

Various embodiments are detailed below. All embodiments comprise some common elements as follows.

A UE has a total number of configurable CORESETs per configured BWP and a total number of search space sets per configured BWP, and a total number of configurable BWPs. Only one BWP may be active at any given time. As of NR Release 15, a UE can have a total of 4 configurable BWPs, each configurable with up to 3 CORESETs and up to 10 search space sets, for a total of 12 available CORESETs and 40 available search space sets. However, these numbers are subject to change, and it is understood that the various embodiments detailed below are not limited to a specific number of BWPs, CORESETs, or SS.

For the purpose of the embodiments described, CORESET 0 and search space set 0 as defined in Third Generation Partnership Project (3GPP) wireless standards (included as a part of the total number of CORESETs and SS) are always active. These channels are “locked down” for critical system information; such information is broadcast all the time and is cell-specific, not UE specific. Thus, search space set 0 cannot be used to receive UE-specific messages like other search space sets. CORESET 0 may be used for UE-specific messages, but it must be connected to other search space sets in order to do so. However, it should be understood that more generally, the embodiments described can still be applied in a context where CORESET 0 and SS 0 are not locked down, and are available for UE specific signalling. Also, different CORESET(s) or search space set(s) may be reserved for system information or other purposes.

In addition, it may not be required to include CORESET 0 in all configured BWPs. In other words, there might be a configured BWP which does not include CORESET 0. Therefore, if the active DL BWP of a UE is switched to a DL BWP which does not have CORESET 0, the UE will not monitor CORESET 0 in the new DL BWP. For such a DL BWP, to enable the UE to receive system information, the network has at least the following choices. In one case, the network may configure a new CORESET to receive system information (e.g. CORESET 7). In another case, before scheduling the system information, the network may first switch the DL BWP of a given UE to another DL BWP which includes CORESET 0 and transmit system information there.

In all following embodiments, a given CORESET is related to a single TRP. A given TRP may be associated with more than one CORESET, but a single CORESET may not be associated with multiple TRPs. Similarly, a given CORESET may be associated with multiple search space sets, but a single search space set may not be associated to more than one CORESET at any given time. However, from the perspective of a UE, it need not be aware of any mapping/association between CORESET, SS and TRP.

More specifically, the UE need not be aware of the TRPs it is connected to. The UE merely deals with the CORESETs and search space sets configured. The primary goal is to activate the necessary CORESETs, whether that is done explicitly or implicitly.

These examples all relate to connections between UE and TRPs; however, it should be understood that a similar approach may be used in respect of sidelink (SL) connections (connections between cooperating UE's).

### Embodiment 1: Search Space Set Activation/Deactivation

In this embodiment, the UE's signaling module for storing search space set configuration includes up to S search space sets per BWP. In some embodiments, S can be any number higher than 10, but this is not a requirement generally. The S search space sets can be configured in one PDCCH-Config information element (IE) or multiple PDCCH-Config IEs.

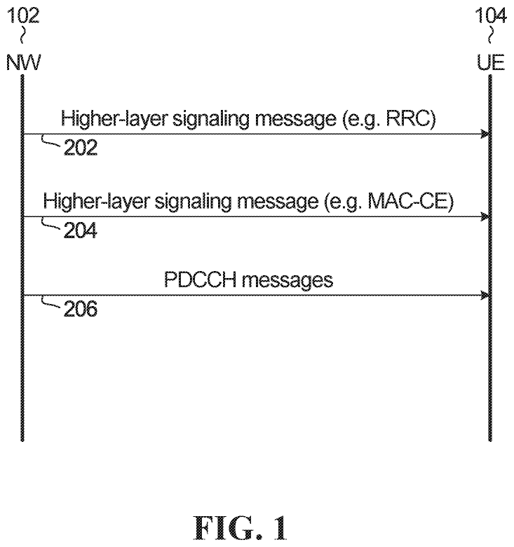

FIG. 1 is a signaling diagram of the messages being exchanged between a network 102 (NW 102) and a given UE 104, and the corresponding UE behavior in response to having received those messages from the network.

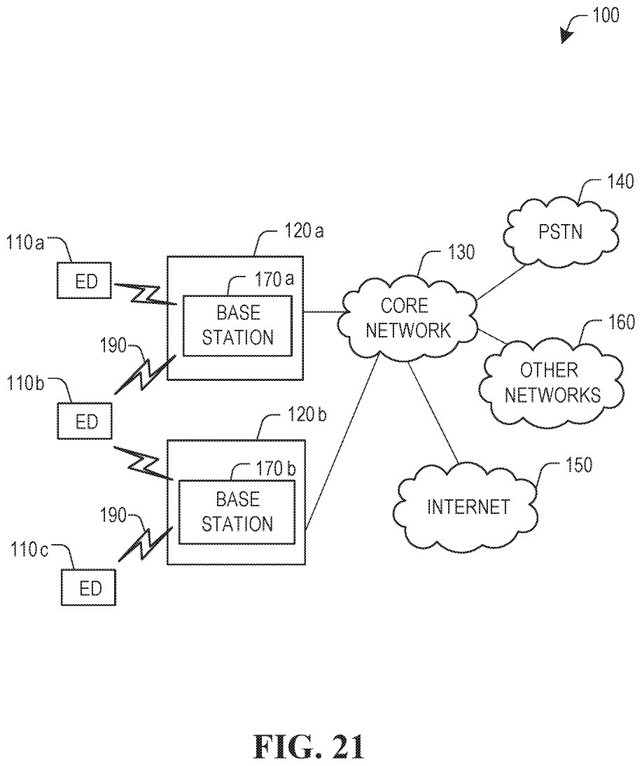

The NW 102 is a telecommunications network of many TRPs capable of transmitting messages, data, and commands to and from UEs via downlink (DL) and uplink (UL) communications. The UE 104 is a device capable of wireless network connection. Examples of UEs include mobile phones, tablets, and smart devices. Further details of networks and UEs suitable for use for this and other embodiments described herein are provided below with reference to FIGS. 21 to 23.

At step 202, the NW 102 sends a higher-layer signaling message to the UE 104 carrying configuration information about CORESETs and associated search space sets. An example of suitable higher-layer signalling is radio resource control (RRC) signalling. Example details of CORESET and SS configuration include the number of each, the types and details of channels in the search space set and how they are connected. In the configuration, each search space set is mapped to one CORESET. Once the UE has the configurations of the CORESET and SS, these configurations are available for activation and subsequent use. Optionally, the CORESET definition may be included in a given search space set, meaning that a CORESET object is defined as part of a search space set object. In this case, the search space set is mapped to the CORESET that is defined as part of the search space set object.

At step 204, the NW 102 sends a command to the UE 104 explicitly indicating the activation or deactivation of one or more search space sets. The UE activates or deactivates the search space sets based on this signalling. Based on knowledge of the mapping between search space sets and CORESETs, the UE implicitly activates or deactivates the associated CORESET(s). In some embodiments, the command is a higher-layer command, such as include media access control-control entity (MAC-CE)), RRC signalling. In other embodiments, the command is sent using physical layer signalling such as downlink control information (DCI)

At step 206, the UE 104 monitors the activated search space sets for NR PDCCH transmissions in the implicitly activated CORESETs based on the configuration. The NW 102 may then send PDCCH messages at any time within the specified SS, which will be received by the UE 104. This method of updating UE-NW connections is described in a specific example as follows.

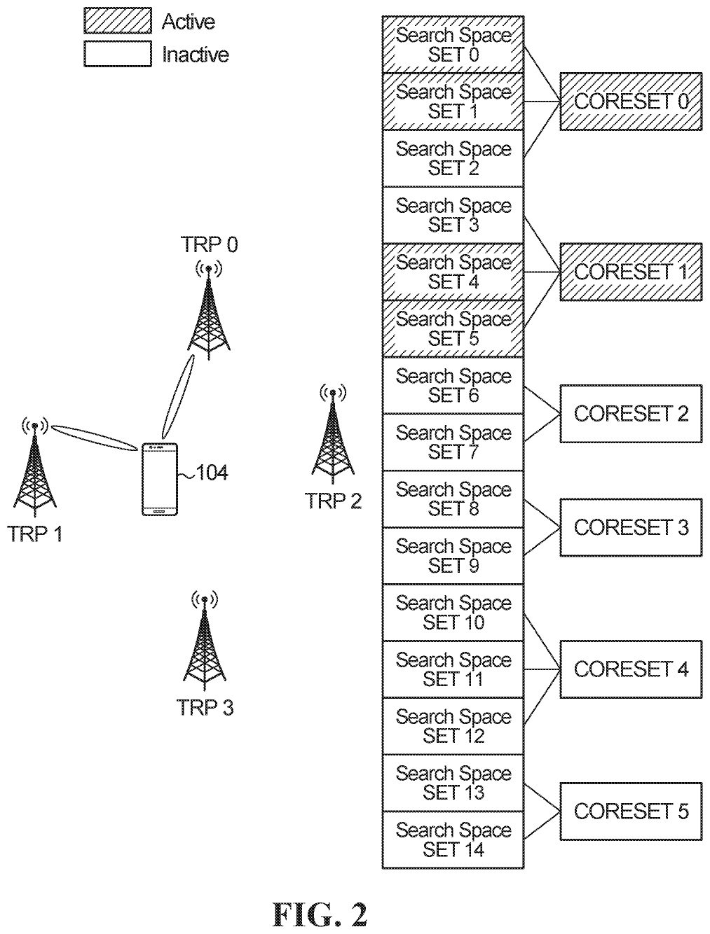

FIG. 2 illustrates a UE 104 that is operating within a network that includes four TRPs: TRP 0, TRP 1, TRP 2 and TRP 3. The UE is configured with 15 search space sets and 6 CORESETs. The mapping between search space set and CORESET is indicated in the right of the Figure. In this mapping:

SS 0, SS 1, SS 2 map to CORESET 0;

SS 3, SS 4, SS 5 map to CORESET 1;

SS 6, SS 7 map to CORESET 2;

SS 8, SS 9 map to CORESET 3,

SS 10, SS 11, SS 12 map to CORESET 4;

SS 13, SS 14 map to CORESET 5;

In this example, TRP 0 is associated with CORESET 0 and TRP 1 is associated with CORESET 1, TRP 2 is associated with CORESET 2, and TRP 3 is associated with CORESET 3. In the illustrated example, search space sets {0, 1, 4, 5} are active and CORESETs 0 and 1 are implicitly activated. Because CORESETs 0 and 1 are associated with TRPs 0 and 1, the result is that the UE will be monitoring for signalling from TRP 0 and 1 on the configured search space sets.

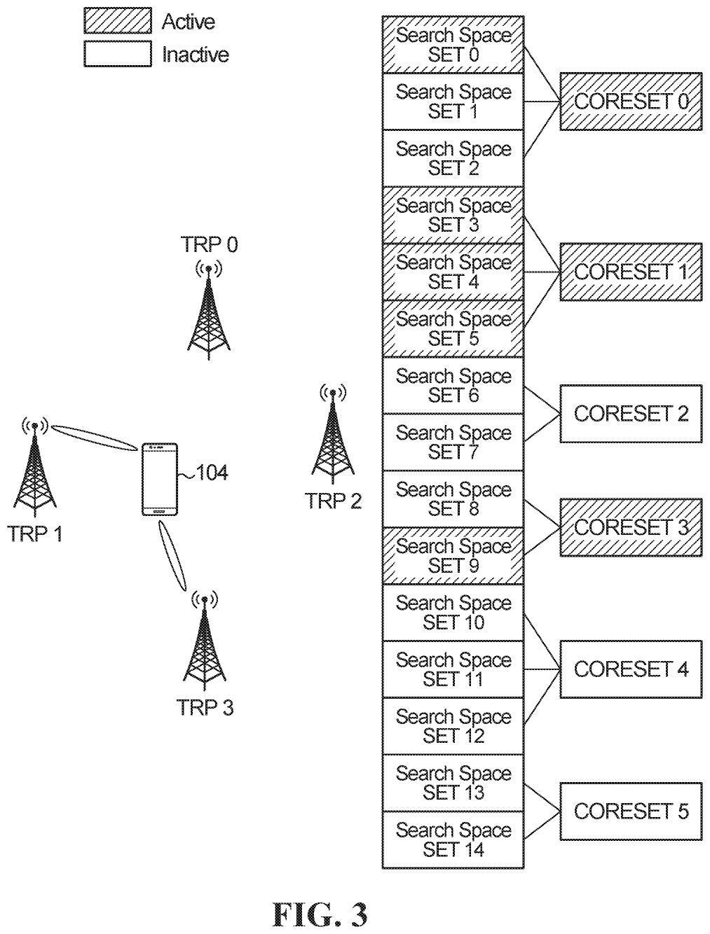

FIG. 3 shows a continuation of the example of FIG. 2, showing SS activation at a later time. Specifically, upon receiving a signaling command explicitly activating search space sets {3, 4, 5, 9}, the UE 104 starts monitoring PDCCH messages on the activated search space sets. These search space sets are associated with CORESETs 1 and 3, which in turn are associated with TRP 1 and TRP 3, so now the UE 104 will be monitoring transmissions from TRP 1 and 3. The CORESETs pertaining to the active search space sets (CORESETs 1 and 3) are implicitly activated. A larger number of Search Space Sets associated with a CORESET may indicate that a given TRP is being used as an anchor TRP, detailed below, but note that the UE 104 receives no indication of which TRP it is communicating with. The UE will be configured to monitor for PDCCH messages scheduling critical system information as well as user-specific data transmissions from a TRP that is an anchor TRP. For a TRP that is not an anchor TRP, the UE is only configured to monitor PDCCH messages scheduling user-specific data transmissions.

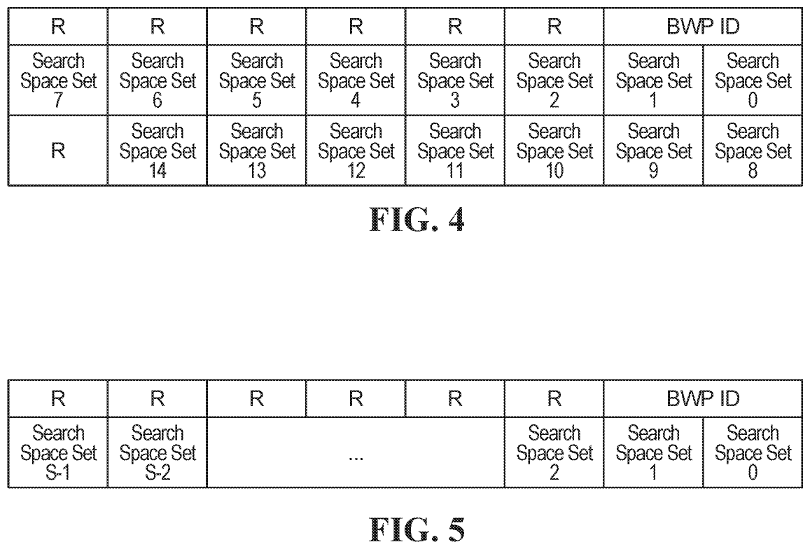

FIG. 4 illustrates an example command which may be implemented as the command in step 204. The command is in the form of a two dimensional bitmap. The first row includes a number of reserved (“R”) bits, as well as two bits to specify the active BWP. The second and third rows contain a respective bit for each of S=15 search space sets, labelled Search Space Set 0 through Search Space Set 14. If the bit for a given search space set is a 0, then that search space set s is deactivated. If the bit for a given search space set is a 1, then that search space set is activated. A command for S search space set activations/deactivations sent in this way allows for 1-bit activation/deactivation of S search space sets. In an alternative embodiment, the association between CORESET and search space set may not be known, and a MAC-CE command for search space set-CORESET association may be implemented to provide a full search space set bitmap per CORESET. More generally, a command structure that contains a respective field for each search space may be employed.

FIG. 5 depicts another example of a command that can be used for this purpose. This example includes two rows: one row with BWP ID, and a second row containing a bit for each search space set, from search space set 0 up to search space set S−1, where S is the number of search space sets.

Embodiment 1 offers higher granular configuration of PDCCH reception and power usage: by activating and deactivating search space sets, the network has greater control on how the UE uses its PDCCH blind decoding budget. This reduces the number of blind decoding assumptions the UE has to go through in order to find the PDCCH message sent by the network. As a side effect, it may also require more UE memory and a larger overhead for SS signaling.

The following is an example of a UE being configured according to the scheme of Embodiment 1: for each downlink bandwidth part configured to the UE in a serving cell, the UE is provided by higher-layers with S search space sets. In some embodiments, S is an integer number higher than 10. For DCI formats that include a CRC scrambled with a UE identifier (where the UE identifier can be any one of a C-RNTI, a MCS-C-RNTI, a CS-RNTI, a SI-RNTI, a P-RNTI, a RA-RNTI, a TC-RNTI, a INT-RNTI, a SFI-RNTI, a TPC-PUSCH-RNTI, a TPC-PUCCH-RNTI, a TPC-SRS-RNTI), the UE monitors PDCCH candidates on one or more activated search space sets of each active DL BWP in each activated serving cell. For each activated DL BWP configured to a UE in a serving cell, the UE expects to be provided with the one or more activated search space sets indicated by a higher layer (e.g. RRC, MAC-CE) or physical layer (e.g. DCI) activation command for the activated DL BWP.

If the UE receives an activation command for one of the search space sets, the UE applies the activation command after the UE has sent an acknowledgement in response to the activation command. If the layer activation command is sent by RRC (e.g. RRC reconfiguration), the UE applies the activation command in the slot after sending an RRC acknowledgement message back to the Network (e.g. RRC reconfiguration complete). If the layer activation command is sent by MAC-CE, the UE applies the activation command in the first slot after slot k+n, where k is the slot where the UE transmits a PUCCH with HARQ-ACK information for the PDSCH providing the activation command and n is the delay to be applied on slot k, where n is a number of slots (n may depend on other parameters such as the numerology, the band/carrier configuration, the BWP configuration, etc.).

In a second example, for DCI formats that include a CRC scrambled with a UE identifier, the UE monitors PDCCH candidates on the CORESETs respectively associated to one or more activated search space sets of each active DL BWP in each activated serving cell. For each activated DL BWP configured to a UE in a serving cell, the UE expects to be provided with the one or more activated search space sets indicated by a higher layer (e.g. RRC, MAC-CE) or physical layer (e.g. DCI) activation command for the activated DL BWP.

In a third example, for DCI formats that include a CRC scrambled with a UE identifier, the UE monitors PDCCH candidates on an implicitly activated CORESET associated to respectively one or more activated search space sets of each active DL BWP in each activated serving cell. For each activated DL BWP configured to a UE in a serving cell, the UE expects to be provided with the one or more activated search space sets indicated by a higher layer (e.g. RRC, MAC-CE) or physical layer (e.g. DCI) activation command for the activated DL BWP.

### Embodiment 2: CORESET Activation/Deactivation

In this embodiment, the UE's signaling module for storing CORESET configuration includes up to N CORESETs. In some embodiments, N can be any number higher than 3, but this is not a requirement generally. The N CORESETs can be configured in one PDCCH-Config IE or multiple PDCCH-Config IEs.

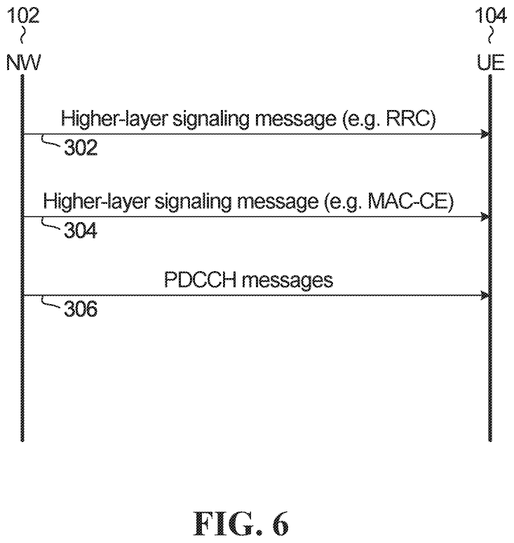

FIG. 6 illustrates a signaling diagram of the messages being exchanged between the NW 102 and the given UE 104, and the corresponding UE behavior in response to having received those messages from the network, according to this second embodiment. At step 302, NW 102 sends a higher-layer signaling message to the UE 104, carrying configuration information about CORESETs and search space sets. In the configuration, each search space set is mapped to one CORESET. Once the UE has the configurations of the CORESET and SS, these configurations are available for activation and subsequent use.

At step 304, NW 102 sends a command to the UE 104 (e.g. higher layer command such as MAC-CE, physical layer command such as DCI), explicitly indicating which CORESETs are active, implicitly activating corresponding search space sets. The UE activates or deactivates the CORESET(s) based on this signalling. Based on knowledge of the mapping between search space sets and CORESETs, the UE implicitly activates or deactivates the associated search space set(s). For instance, the MAC-CE command may update search space set configuration to update a ControlResourceSetID field. The UE 104 then updates its CORESET to SS association tree.

At step 306, based on the configuration sent by the higher-layer signaling and the active configuration indicated by the activation command, the UE 104 monitors PDCCH messages on each implicitly activated search space set corresponding to the activated CORESET(s) (i.e. search space sets whose bandwidth falls within the CORESET specification for PDCCH demodulation reference signals (DMRS)). This method of updating UE-NW connections is described in a specific example as follows.

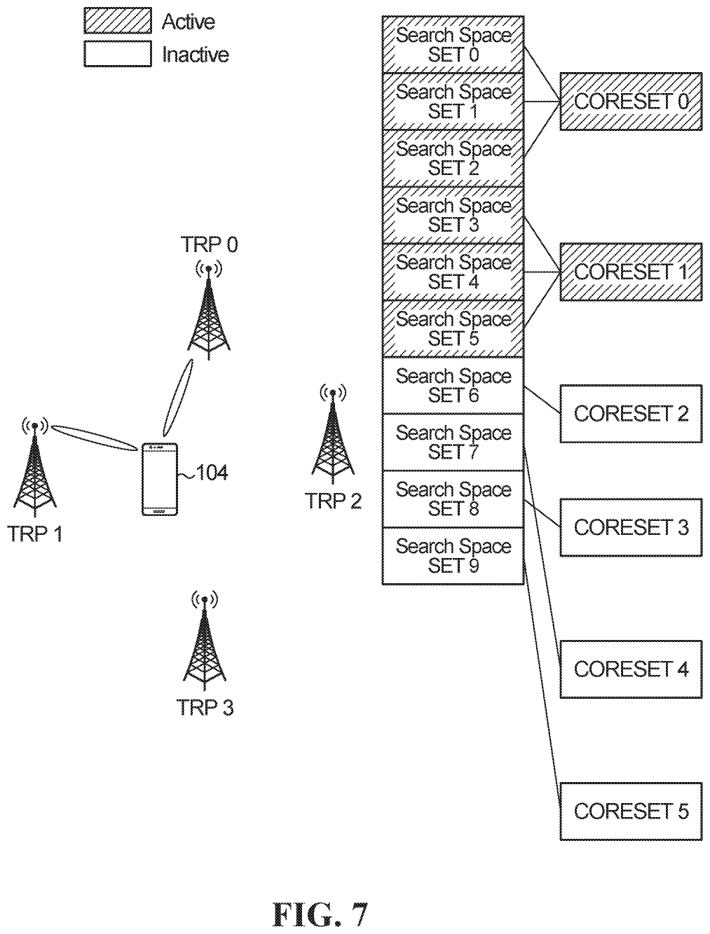

FIG. 7 illustrates the given UE 104 that is that is operating within a network that includes four TRPs: TRP 0, TRP 1, TRP 2 and TRP 3. The UE is configured with 6 CORESETs and 10 search space sets. The mapping between search space set and CORESET is indicated in the right of the Figure. In this mapping:

SS 0, SS 1, SS 2 map to CORESET 0;

SS 3, SS 4, SS 5 map to CORESET 1;

SS 6 maps to CORESET 2;

SS 7 maps to CORESET 4,

SS 8 maps to CORESET 3;

SS 9 maps to CORESET 5;

In this example, TRP 0 is associated with CORESET 0, TRP 1 is associated with CORESET 1, TRP 2 is associated with CORESET 2, and TRP 3 is associated with CORESET 3. In the illustrated example, CORESETs {0, 1} are active and search space sets 0, 1, 2, 3, 4, and 5 are implicitly activated. Because CORESETs 0 and 1 are associated with TRPs 0 and 1, the result is that the UE will be monitoring for signalling from TRP 0 and 1 on the configured search space sets.

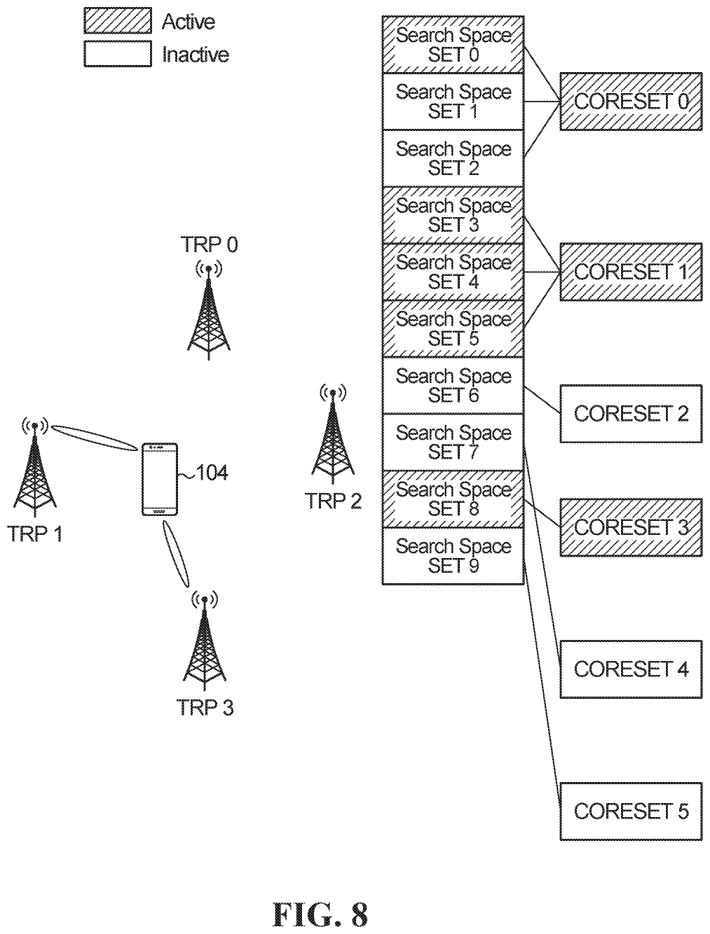

FIG. 8 shows a continuation of the example of FIG. 7, showing SS activation at a later time. Specifically, upon receiving signaling command activating CORESETs {1, 3}, the UE 104 starts monitoring PDCCH messages on search space sets associated with the activated CORESETs. These CORESETs are associated with TRPs 1 and 3, so now the UE 104 will be monitoring transmissions from TRPs 1 and 3. CORESET 0 remains active, but only as it pertains to search space set 0 and monitoring critical system information.

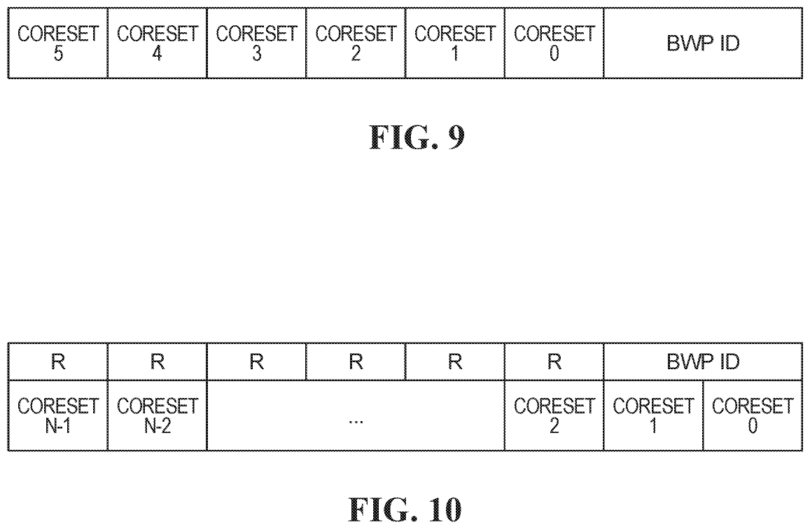

FIG. 9 depicts an example command sent by NW 102 to activate/deactivate CORESETs. The command is in the form of a one dimensional bitmap. The bitmap includes two bits to specify the active BWP; the bitmap further contains a respective bit for each of N=6 CORESETs. If the bit for a given CORESET is a 1, that CORESET is activated; if the bit for a given CORESET is a 0, that CORESET is deactivated. A command for N CORESET activations/deactivations sent in this way allows for 1-bit activation/deactivation of N CORESETs. More generally, a command structure that contains a respective field for each CORESET may be employed.

FIG. 10 depicts another example of a command that can be used to activate/deactivate CORESETs. This example is two-dimensional and includes two rows: one row with BWP ID and a number of reserved (“R”) bits, and a second row containing a bit for each CORESET, from CORESET to CORESET N−1, where N is the number of CORESETs.

Embodiment 2 offers a low complexity solution for UE power management, generating a smaller CORESET/search space set association tree. It also offers a higher number of CORESETs per BWP (i.e. an integer greater than 3).

However, this solution offers coarser configuration and usage of search space sets and may require a larger overhead for CORESET related signaling.

The following is an example of a UE being configured according to the scheme of Embodiment 2: for each downlink bandwidth part configured to the UE in a serving cell, the UE is provided by higher-layers with P CORESETs (where P is an integer number higher than 3). For each CORESET, the UE is provided with a CORESET index p (where p is an integer number higher than or equal to 0).

For DCI formats that include CRC scrambled with a UE identifier (where the UE identifier can be any one of a C-RNTI, a MCS-C-RNTI, a CS-RNTI, a SI-RNTI, a P-RNTI, a RA-RNTI, a TC-RNTI, a INT-RNTI, a SFI-RNTI, a TPC-PUSCH-RNTI, a TPC-PUCCH-RNTI, a TPC-SRS-RNTI), the UE monitors PDCCH candidates on one or more activated CORESETs of each active DL BWP in each activated serving cell. For each activated DL BWP configured to a UE in a serving cell, the UE expects to be provided with the one or more activated CORESETs indicated by a higher layer (e.g. RRC, MAC-CE) or physical layer (e.g. DCI) activation command for the activated DL BWP.

If the UE receives an activation command for one of the CORESETs, the UE applies the activation command after the UE has sent an acknowledgement in response to the activation command. If the layer activation command is sent by RRC (e.g. RRC reconfiguration), the UE applies the activation command in the slot after sending an RRC acknowledgement message back to the Network (e.g. RRC reconfiguration complete). If the layer activation command is sent by MAC-CE, the UE applies the activation command in the first slot after slot k+n, where k is the slot where the UE transmits a PUCCH with HARQ-ACK information for the PDSCH providing the activation command and n is the delay (in slots) to be applied on slot k (n may depend on other parameters such as the numerology, the band/carrier configuration, the BWP configuration, etc.).

### Embodiment 3: CORESET-SS Link Activation/Deactivation

In this embodiment, the UE's signaling module for storing CORESET and search space set configuration includes up to M CORESETs and S search space sets. In some embodiments, M can be any number higher than 3 and S can be any number higher than 10. The M CORESETs and S search space sets can be configured in one PDCCH-Config IE or multiple PDCCH-Config IEs.

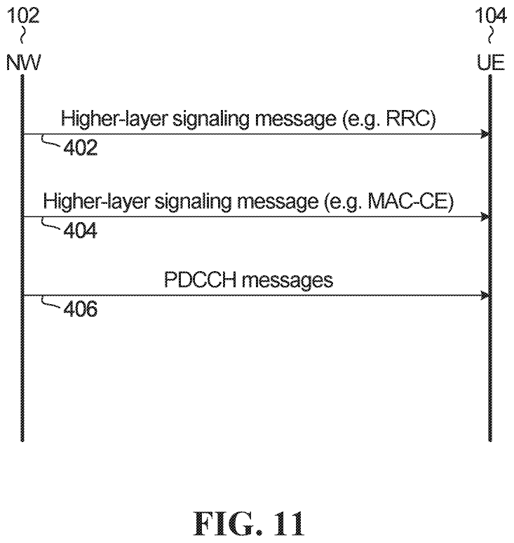

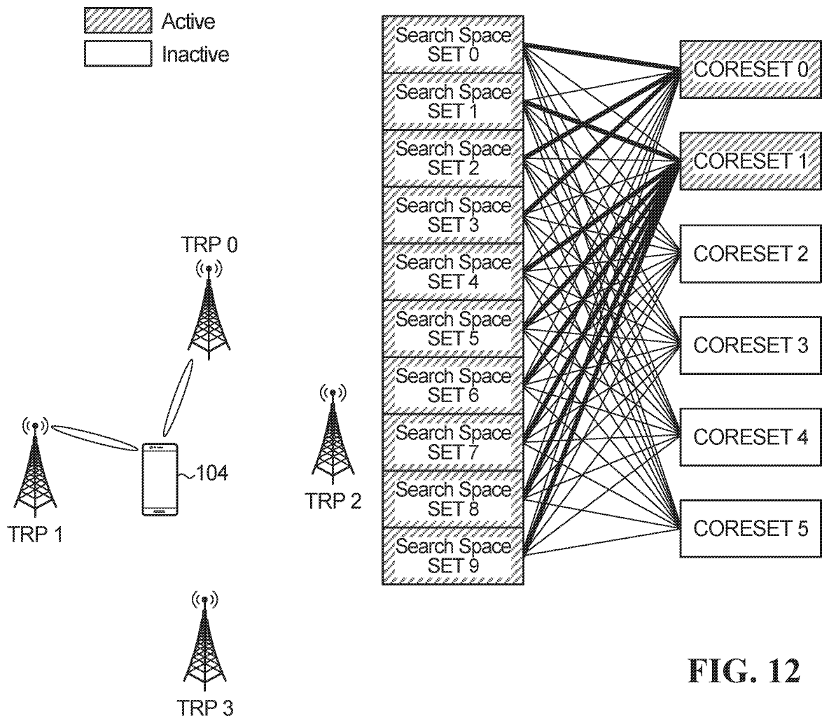

FIG. 11 illustrates a signaling diagram of the messages being exchanged between the NW 102 and the given UE 104, and the corresponding UE behavior in response to having received those messages from the network, according to this third embodiment. FIG. 11 will be described with some reference to FIG. 12 which shows a specific example of this approach. FIG. 12 illustrates the UE 104 that is operating within a network that includes four TRPs: TRP 0, TRP 1, TRP 2 and TRP 3. At step 402, the NW 102 sends a higher-layer signaling message to the UE 104 (e.g. RRC), carrying configuration information about CORESETs and search space sets. Each search space set is available to be mapped to each configured CORESETs. In the example of FIG. 12, there are 10 configured search space sets, and 6 configured CORESETs, and there is a line that interconnects each search space set to each CORESET indicating that each space set can be mapped to each CORESET

Once the UE has the configurations of the CORESET and SS, these configurations are available for activation and subsequent use. In this embodiment, all search space sets configured using higher-layer signaling are active. In a given configuration, each search space set can map to any CORESET, but for each search space set, only one link is active at a time.

At step 404, the NW 102 sends a signaling command to the UE 104 (e.g. higher layer command such as MAC-CE, physical layer command such as DCI), explicitly activating or deactivating one or more CORESET-SS links. The UE activates or deactivates the CORES ET-SS links based on this signalling. Based on knowledge of the CORESET-SS links between search space sets and CORESETs, the UE implicitly activates or deactivates the associated search space set(s) and CORESET(s). Multiple CORESETs and multiple search space sets are configured in one PDCCH configuration. In the example of FIG. 12, the bolded CORESET-SS links (one per search space set) are active. The active links include:

### Search Space Set 0→CORESET 0,

### Search Space Set 1→CORESET 1,

### Search Space Set 2→CORESET 0,

### Search Space Set 3→CORESET 0,

### Search Space Set 4→CORESET 1,

### Search Space Set 5→CORESET 1,

### Search Space Set 6→CORESET 1,

### Search Space Set 7→CORESET 1,

### Search Space Set 8→CORESET 1,

### Search Space Set 9→CORESET 1,

At Step 406, based on the configuration sent by the higher-layer signaling and the active configuration indicated by the activation command, the UE 104 monitors PDCCH messages on each activated search space set corresponding to the activated CORES ET-SS link(s) (and implicitly each activated CORESET). This method of updating UE-NW connections is described in a specific example as follows.

In this example, TRP 0 is associated with CORESET 0 and TRP 1 is associated with CORESET 1, TRP 2 is associated with CORESET 2, and TRP 3 is associated with CORESET 3. In the illustrated example, CORESET-SS links leading to CORESETs {0, 1} are active. As consistent with other embodiments, each search space set only has once CORESET-SS link activated, as a single SS cannot connect to multiple CORESETs. However, each CORESET may have a number of CORESET-SS links active. Because CORESETs 0 and 1 are associated with TRPs 0 and 1, the result is that the UE will be monitoring for signalling from TRP 0 and 1 on the configured search space sets.

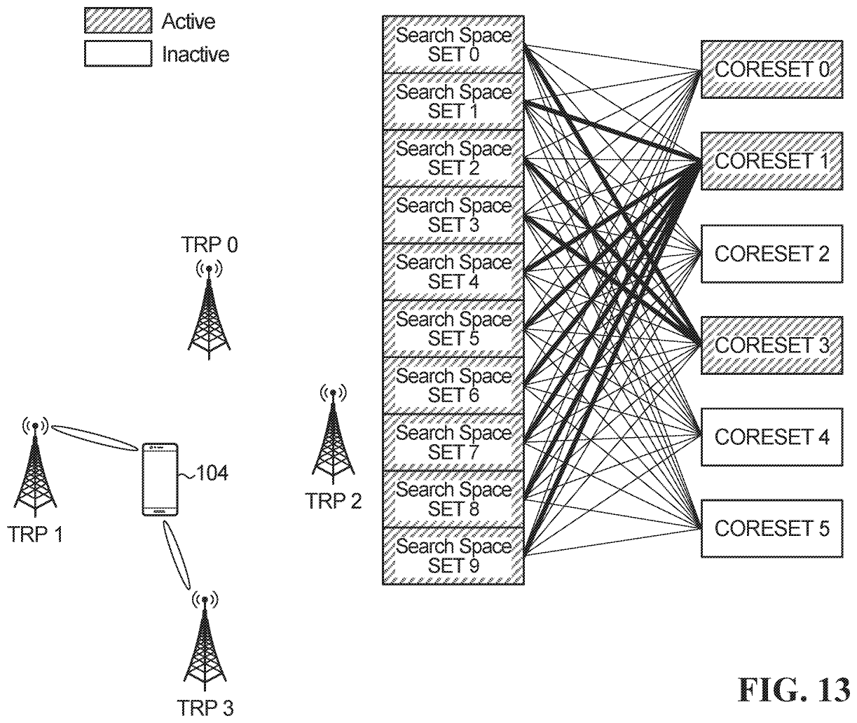

FIG. 13 shows a continuation of the example of FIG. 12, showing SS activation at a later time. Specifically, upon receiving an activation command activating CORESET-SS links leading to CORESETs {1, 3}, the UE 104 updates its CORESET to search space set associations and starts monitoring PDCCH messages on the search space sets connected to the activated CORESETs. These CORESETs are associated with TRPs 1 and 3, so now the UE 104 will be monitoring transmissions from TRPs 1 and 3. Embodiment 3 offers higher granular configuration of PDCCH reception and power usage: by activating and deactivating CORESET-SS links, the network has full control on how the UE uses its PDCCH blind decoding budget. This reduces the number of blind decoding assumptions the UE has to go through in order to find the PDCCH message sent by the network. It is the most flexible and granular solution of the embodiments.

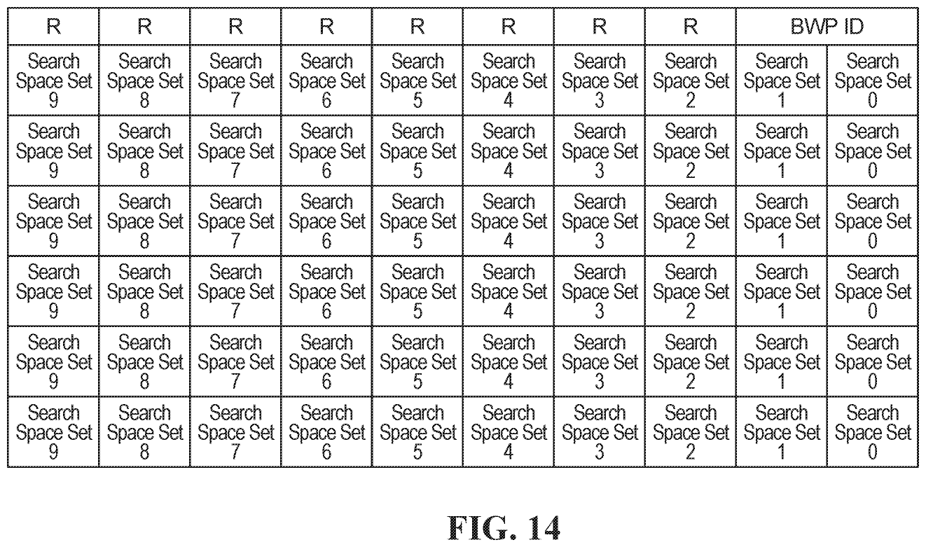

FIG. 14 depicts an example activation command sent by NW 102 to activate/deactivate CORESET-SS links. The command is in the form of a two dimensional bitmap. The first row is optional, and includes a number of reserved (“R”) bits, as well as two bits to specify the active BWP. The remaining C=6 rows contain a matrix with a respective bit for each of S*C=60 CORESET-SS links (where S is the number of search space sets and C is the number of CORESETs). In this matrix, the column indicates the search space set (for example, search space sets 0 to 9 may be associated with columns in the matrix from left to right) and the row indicates the CORESET (for example, CORESETs 0 to 5 may be associated with rows in the matrix from the top to the bottom). if the bit (coordinate) for a CORESET-SS link has a 1, then that CORESET-SS link is activated; if the bit for a CORESET-SS link is a 0, that CORESET-SS link is deactivated (e.g. the bit in the first column, third row corresponds to search space set 9 and CORESET 1; the 1 indicates that link is active). In the bitmap sent, each column may only have a single 1 to indicate an active link, because each SS can only connect to one CORESET. A command for CORESET-SS link activations/deactivations sent in this way allows for 1-bit activation/deactivation of CORESET-SS links. More generally, a command structure that contains a respective field for each CORES ET-SS link may be employed.

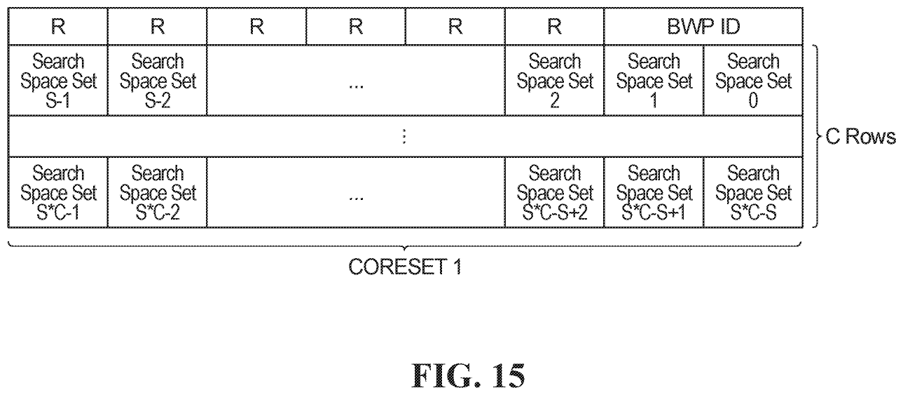

FIG. 15 depicts another example of a command that can be used for this purpose. FIG. 14 is a generalization of FIG. 13 for a set of C CORESETs and S search space sets. The command again includes an optional first row with BWP ID and a number of reserved (“R”) bits, followed by C rows containing S bits for each CORESET, representing the S possible CORESET-SS links involving that CORESET.

In this embodiment, all configured search space sets are always active. However, all available search space sets need not be configured at a time.

The introduction of CORESET-SS links may reduce initial configuration overhead (e.g. RRC), because linkage information for CORESETs and search space sets does not need to be provided. However, Embodiment 3 also has a higher operational configuration overhead from CORESET-SS activation tree signaling; all links need to be configured during operation (for example by MAC-CE commands). Also, this embodiment has higher UE complexity due to always active search space sets.

The following is an example of a UE being configured according to the scheme of Embodiment 3: for each downlink bandwidth part configured to the UE in a serving cell, the UE is provided by higher-layers with S search space sets. In some embodiments, S is an integer number higher than 10. For each search space set, the UE is provided with a SearchSpace information element (IE) that can, for example, have the following structure:

```
SearchSpace {
  searchSpaceId,
  monitoringSlotPeriodicityAndOffset,
  duration,
  monitoringSymbolsWithinSlot,
  numberofCandidates,
  searchSpaceType
}
```

For DCI formats that include CRC scrambled with a UE identifier (where the UE identifier can be any one of a C-RNTI, a MCS-C-RNTI, a CS-RNTI, a SI-RNTI, a P-RNTI, a RA-RNTI, a TC-RNTI, a INT-RNTI, a SFI-RNTI, a TPC-PUSCH-RNTI, a TPC-PUCCH-RNTI, a TPC-SRS-RNTI), the UE monitors PDCCH candidates on one or more activated pairs of {CORESET-search space set} of each active DL BWP in each activated serving cell. For each activated DL BWP configured to a UE in a serving cell, the UE expects to be provided, for each search space set configured to the UE, with one or more pairs of {CORESET-search space set} indicated by an activation command for the activated DL BWP.

If the UE receives an activation command for one of the pairs of {CORESET-search space set}, the UE applies the activation command after the UE has sent an acknowledgement in response to the activation command, so that the network will know the activation command was received and executed. If the activation command is sent by RRC (e.g. RRC reconfiguration), the UE applies the activation command in the slot after sending an RRC acknowledgement message back to the Network (e.g. RRC reconfiguration complete). If the activation command is sent by MAC-CE, the UE applies the activation command in the first slot after slot k+n, where k is the slot where the UE transmits a PUCCH with HARQ-ACK information for the PDSCH providing the activation command and n is the delay (in slots) to be applied on slot k (n may depend on other parameters such as the numerology, the band/carrier configuration, the BWP configuration, etc.).

In a second example: for DCI formats that include CRC scrambled with a UE identifier, the UE monitors PDCCH candidates on one or more activated CORESETs of each active DL BWP in each activated serving cell. For each activated DL BWP configured to the UE, the UE expects to be provided with one or more pairs of {CORESET-search space set}, indicated by an activation command for the activated DL BWP, to indicate the one or more activated CORESETs.

In a third example: for DCI formats that include CRC scrambled with a UE identifier, the UE monitors PDCCH candidates on one or more search space sets of each active DL BWP in each activated serving cell. For each activated DL BWP configured to the UE, the UE expects to be provided with one or more pairs of {CORESET-search space set}, indicated by an activation command for the activated DL BWP, to indicate the one or more implicitly activated CORESETs.

### Embodiment 4: PDCCH-Config Activation/Deactivation

In this embodiment, the UE's signaling module for storing CORESET and search space set configuration includes up to M CORESETs and S search space sets. In some embodiments, M can be any number higher than 3 and S can be any number higher than 10. The M CORESETs and S search space sets are configured in multiple PDCCH-Config IEs. This embodiment provides multiple configurations per BWP.

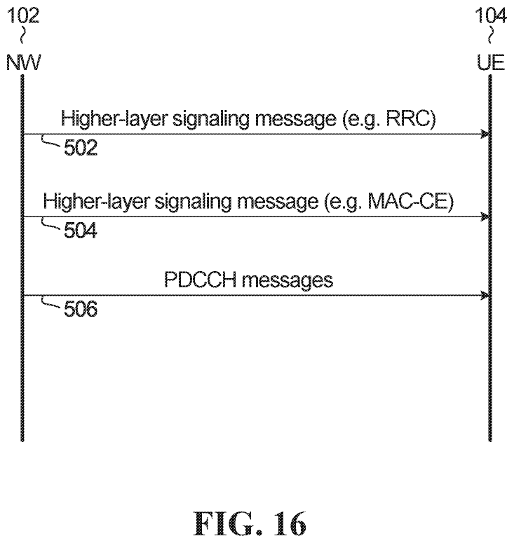

FIG. 16 is a signaling diagram of the messages being exchanged between the NW 102 and the UE 104, and the corresponding UE behavior in response to having received those messages from the network

At step 502, the network sends a higher-layer signaling message to the UE 104 (e.g. RRC), carrying configuration information about CORESETs and search space sets. CORESETs and corresponding search space sets are configured on a per PDCCH-Config IE basis. In the configuration, each search space set maps to one CORESET. Once the UE has the configurations of the CORESET and SS, these configurations are available for activation and subsequent use.

At step 504, the network sends an activation command to the UE (e.g. higher layer command such as MAC-CE, physical layer command such as DCI), indicating activating or deactivating a PDCCH-Config IE. The UE activates or deactivates the PDCCH-Config IE based on this signalling. Based on knowledge of the mapping between search space sets and CORESETs laid out in the PDCCH-Config IE, the UE activates or deactivates the associated Search space set(s) and CORESET(s).

At step 506, based on the configuration sent by the higher-layer signaling and the active configuration indicated by the activation command, the UE 104 monitors PDCCH messages on each search space set corresponding to the activated PDCCH-Config IE (and implicitly each activated CORESET). This method of updating UE-NW connections is described in a specific example as follows.

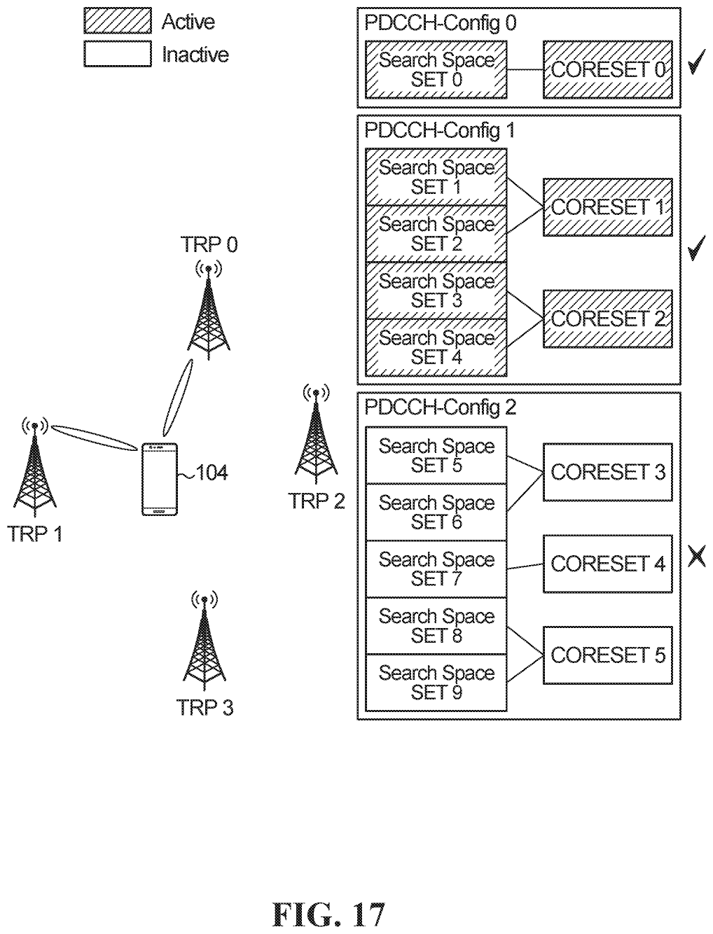

FIG. 17 illustrates the UE that is that is operating within a network that includes four TRPs: TRP 0, TRP 1, TRP 2 and TRP 3. The UE is configured with 6 CORESETs and 10 search space sets. A PDCCH-Config IE 1 is in use. The mapping between search space set and CORESET. Within each PDCCH-Config IE is indicated in the right of the Figure. In this mapping:

### In PDCCH-Config 0:

SS 0 maps to CORESET 0;

### in PDCCH-Config 1:

### SS 1, SS 2 map to CORESET 1;

### SS 3, SS 4 map to CORESET 2;

### in PDCCH-Config 2:

SS 5, SS 6 map to CORESET 3,

SS 7 maps to CORESET 4;

### SS 8, SS 9 map to CORESET 5;

In this example, TRP 0 is associated with CORESET 1 and TRP 1 is associated with CORESET 2. Neither other TRP has an association, because they will only receive an association while in communication with the UE. In the illustrated example, CORESETs 1 and 2 are active, as are the corresponding Search Space Sets 1, 2, 3, and 4. Because CORESETs 1 and 2 are associated with TRPs 0 and 1, the result is that the UE will be monitoring for signalling from TRP 0 and 1 on the configured search space sets. An additional PDCCH-Config IE 0 indicates that CORESET 0 and SS 0 are always active to receive critical system information.

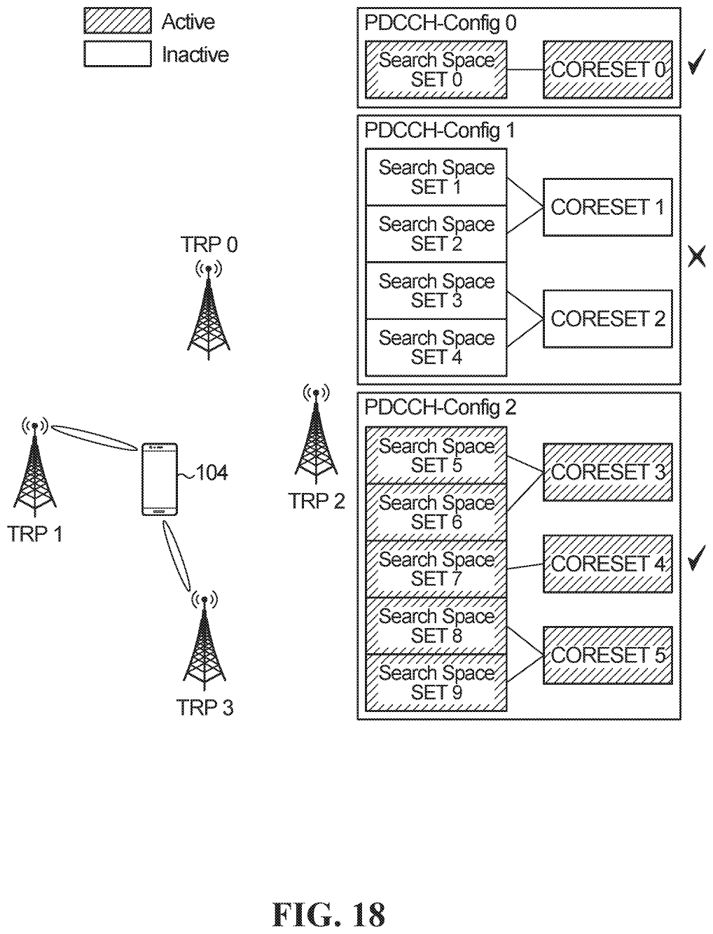

FIG. 18 shows a continuation of the example of FIG. 17, showing SS activation at a later time. Specifically, upon receiving a activation command explicitly activating PDCCH-Config 2, the UE 104 starts monitoring PDCCH messages on the implicitly activated search space sets and corresponding CORESETs. These CORESETs are associated with TRPs 1 and 3, so now the UE 104 will be monitoring transmissions from TRPs 1 and 3. Specifically, CORESETs 3 and 4 are associated with TRP 1 and CORESET 5 is associated with TRP 3.

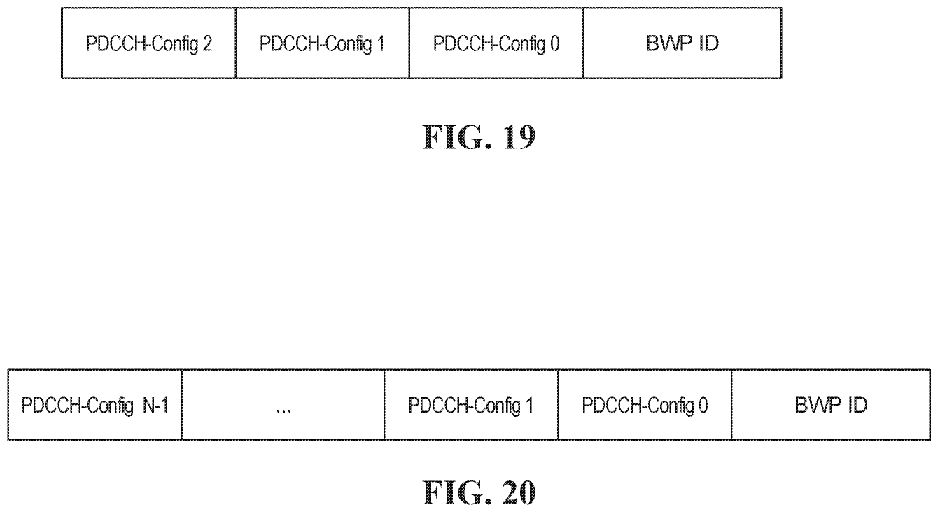

FIG. 19 depicts an example activation command sent by NW 102 to activate/deactivate PDCCH-Config IEs. The command is in the form of a one dimensional bitmap. The bitmap includes two bits to specify the active BWP; the bitmap further contains a respective bit for each of P=3 PDCCH-Config IEs. If the bit for a PDCCH-Config IE is a 1, that PDCCH-Config IE is activated (implicitly activating related CORESETs and SS); if the bit is a 0, that PDCCH-Config IE is deactivated (implicitly deactivating related CORESETs and SS). A command for P PDCCH-Config IE activations/deactivations sent in this way allows for 1-bit activation/deactivation of PDCCH-Config IEs.

FIG. 20 shows another example of a command that can be used for this purpose. This example includes two rows: one row with BWP ID and a number of reserved (“R”) bits, and a second row containing a bit for each PDCCH-Config IE, from PDCCH-Config IE 0 to N−1, where N is the number of PDCCH-Config IEs configured.

Embodiment 4 offers low complexity UE power management: the UE manages smaller CORESET-SS trees based on sub-sets of CORESETs and search space sets, activated by the corresponding PDCCH-Config IE. This embodiment requires smaller CORESET-SS trees. This embodiment also has very low operational overhead, because higher level signaling (i.e. MAC-CE) only has to indicate which PDCCH-Config IE is to be used.

However, this embodiment is a coarse use of CORESET-SS and requires a higher initial signaling overhead to configure PDCCH-Config IEs (e.g. configuration of transmit power control (TPC) physical uplink shared channel (PUSCH), TPC physical uplink control channel (PUCCH), TPC sounding reference signal (SRS)). The following is an example of a UE being configured according to the scheme of Embodiment 4: for each downlink bandwidth part configured to the UE in a serving cell, the UE is provided by higher-layers with M PDCCH-Config objects (where M is an integer number higher than 1). For each PDCCH-Config object, the UE is provided with one or more search space sets and one or more CORESETs.

For DCI formats that include CRC scrambled with a UE identifier (where the UE identifier can be any one of a C-RNTI, a MCS-C-RNTI, a CS-RNTI, a SI-RNTI, a P-RNTI, a RA-RNTI, a TC-RNTI, a INT-RNTI, a SFI-RNTI, a TPC-PUSCH-RNTI, a TPC-PUCCH-RNTI, a TPC-SRS-RNTI), the UE monitors PDCCH candidates on each activated PDCCH-Config of each active DL BWP in each activated serving cell. For each activated DL BWP configured to a UE in a serving cell, the UE expects to be provided, for each search space set configured to the UE, with one or more activated PDCCH-Config indicated by an) activation command for the activated DL BWP.

If the UE receives a activation command for one of the PDCCH-Configs, the UE applies the activation command after the UE has sent an acknowledgement in response to the activation command. If the layer activation command is sent by RRC (e.g. RRC reconfiguration), the UE applies the activation command in the slot after sending an RRC acknowledgement message back to the Network (e.g. RRC reconfiguration complete). If the layer activation command is sent by MAC-CE, the UE applies the activation command in the first slot after slot k+n, where k is the slot where the UE transmits a PUCCH with HARQ-ACK information for the PDSCH providing the activation command and n is the delay (in slots) to be applied on slot k (n may depend on other parameters such as the numerology, the band/carrier configuration, the BWP configuration, etc.).

In a second example: for DCI formats that include CRC scrambled with a UE identifier, the UE monitors PDCCH candidates on one or more CORESETs of each active DL BWP in each activated serving cell. For each activated DL BWP configured to a UE in a serving cell, the UE expects to be provided with one or more PDCCH-Config indicated by an activation command for the activated DL BWP, to indicate the one or more activated CORESETs.

In a third example: for DCI formats that include CRC scrambled with a UE identifier, the UE monitors PDCCH candidates on one or more search space sets of each active DL BWP in each activated serving cell. For each activated DL BWP configured to a UE in a serving cell, the UE expects to be provided with one or more PDCCH-Config indicated by an activation command for the activated DL BWP, to indicate the one or more activated search space sets.

FIG. 21 illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, narrowcast, user device to to user device, etc. The communication system 100 may operate by sharing resources such as bandwidth.

In this example, the communication system 100 includes electronic devices (ED) 110a-110c, radio access networks (RANs) 120a-120b, a core network 130, a public switched telephone network (PSTN) 140, the internet 150, and other networks 160. Although certain numbers of these components or elements are shown in FIG. 1, any reasonable number of these components or elements may be included in the communication system 100.

The EDs 110a-110c are configured to operate, communicate, or both, in the communication system 100. For example, the EDs 110a-110c are configured to transmit, receive, or both via wireless or wired communication channels. Each ED 110a-110c represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 20, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission point (TP), a site controller, an access point (AP), or a wireless router. Any ED 110a-110c may be alternatively or additionally configured to interface, access, or communicate with any other base station 170a-170b, the internet 150, the core network 130, the PSTN 140, the other networks 160, or any combination of the preceding. The communication system 100 may include RANs, such as RAN 120b, wherein the corresponding base station 170b accesses the core network 130 via the internet 150, as shown.

The EDs 110a-110c and base stations 170a-170b are examples of communication equipment that can be configured to implement some or all of the functionality and/or embodiments described herein. In the embodiment shown in FIG. 21, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b communicate with one or more of the EDs 110a-110c over one or more air interfaces 190 using wireless communication links e.g. radio frequency (RF), microwave, infrared (IR), etc. The air interfaces 190 may utilize any suitable radio access technology. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190.

A base station 170a-170b may implement Universal Mobile Telecommunication System (UMTS) Terrestrial Radio Access (UTRA) to establish an air interface 190 using wideband CDMA (WCDMA). In doing so, the base station 170a-170b may implement protocols such as HSPA, HSPA+ optionally including HSDPA, HSUPA or both. Alternatively, a base station 170a-170b may establish an air interface 190 with Evolved UTMS Terrestrial Radio Access (E-UTRA) using LTE, LTE-A, and/or LTE-B. It is contemplated that the communication system 100 may use multiple channel access functionality, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160). In addition, some or all of the EDs 110a-110c may include functionality for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as IP, TCP, UDP. EDs 110a-110c may be multimode devices capable of operation according to multiple radio access technologies, and incorporate multiple transceivers necessary to support such.

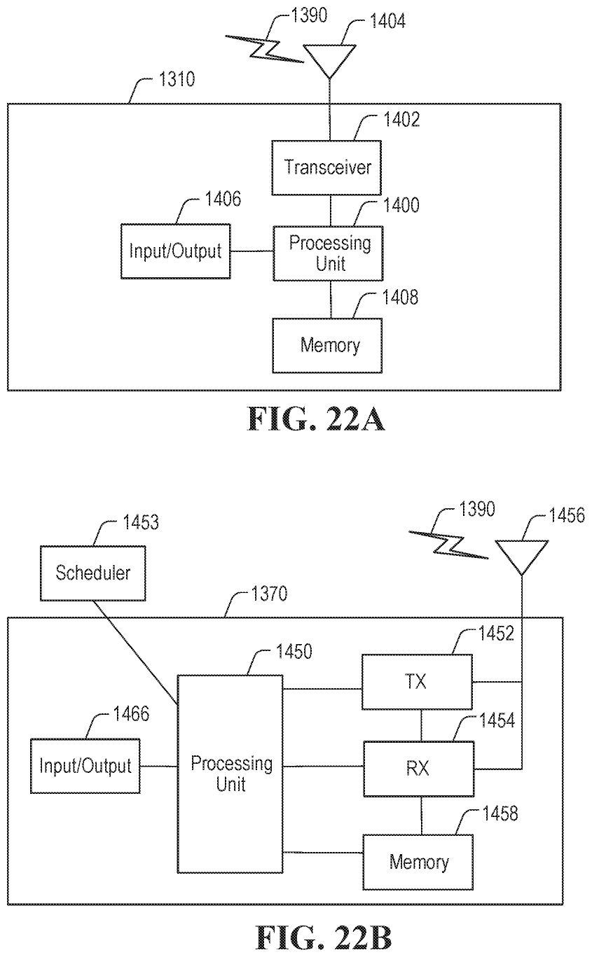

FIGS. 22A and 22B illustrate example devices that may implement the methods and teachings according to this disclosure. In particular, FIG. 22A illustrates an example ED 110, and FIG. 22B illustrates an example base station 170. These components could be used in the communication system 100 or in any other suitable system.

As shown in FIG. 22A, the ED 110 includes at least one processing unit 200. The processing unit 200 implements various processing operations of the ED 110. For example, the processing unit 200 could perform signal coding, data processing, power control, input/output processing, or any other functionality enabling the ED 110 to operate in the communication system 100. The processing unit 200 may also be configured to implement some or all of the functionality and/or embodiments described in more detail above. Each processing unit 200 includes any suitable processing or computing device configured to perform one or more operations. Each processing unit 200 could, for example, include a microprocessor, microcontroller, digital signal processor, field programmable gate array, or application specific integrated circuit.

The ED 110 also includes at least one transceiver 202. The transceiver 202 is configured to modulate data or other content for transmission by at least one antenna or Network Interface Controller (NIC) 204. The transceiver 202 is also configured to demodulate data or other content received by the at least one antenna 204. Each transceiver 202 includes any suitable structure for generating signals for wireless or wired transmission and/or processing signals received wirelessly or by wire. Each antenna 204 includes any suitable structure for transmitting and/or receiving wireless or wired signals. One or multiple transceivers 202 could be used in the ED 110. One or multiple antennas 204 could be used in the ED 110. Although shown as a single functional unit, a transceiver 202 could also be implemented using at least one transmitter and at least one separate receiver.

The ED 110 further includes one or more input/output devices 206 or interfaces (such as a wired interface to the internet 150). The input/output devices 206 permit interaction with a user or other devices in the network. Each input/output device 206 includes any suitable structure for providing information to or receiving information from a user, such as a speaker, microphone, keypad, keyboard, display, or touch screen, including network interface communications.

In addition, the ED 110 includes at least one memory 208. The memory 208 stores instructions and data used, generated, or collected by the ED 110. For example, the memory 208 could store software instructions or modules configured to implement some or all of the functionality and/or embodiments described above and that are executed by the processing unit(s) 200. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, and the like.

As shown in FIG. 22B, the base station 170 includes at least one processing unit 250, at least one transmitter 252, at least one receiver 254, one or more antennas 256, at least one memory 258, and one or more input/output devices or interfaces 266. A transceiver, not shown, may be used instead of the transmitter 252 and receiver 254. A scheduler 253 may be coupled to the processing unit 250. The scheduler 253 may be included within or operated separately from the base station 170. The processing unit 250 implements various processing operations of the base station 170, such as signal coding, data processing, power control, input/output processing, or any other functionality. The processing unit 250 can also be configured to implement some or all of the functionality and/or embodiments described in more detail above. Each processing unit 250 includes any suitable processing or computing device configured to perform one or more operations. Each processing unit 250 could, for example, include a microprocessor, microcontroller, digital signal processor, field programmable gate array, or application specific integrated circuit.

Each transmitter 252 includes any suitable structure for generating signals for wireless or wired transmission to one or more EDs or other devices. Each receiver 254 includes any suitable structure for processing signals received wirelessly or by wire from one or more EDs or other devices. Although shown as separate components, at least one transmitter 252 and at least one receiver 254 could be combined into a transceiver. Each antenna 256 includes any suitable structure for transmitting and/or receiving wireless or wired signals. Although a common antenna 256 is shown here as being coupled to both the transmitter 252 and the receiver 254, one or more antennas 256 could be coupled to the transmitter(s) 252, and one or more separate antennas 256 could be coupled to the receiver(s) 254. Each memory 258 includes any suitable volatile and/or non-volatile storage and retrieval device(s) such as those described above in connection to the ED 110. The memory 258 stores instructions and data used, generated, or collected by the base station 170. For example, the memory 258 could store software instructions or modules configured to implement some or all of the functionality and/or embodiments described above and that are executed by the processing unit(s) 250.

Each input/output device 266 permits interaction with a user or other devices in the network. Each input/output device 266 includes any suitable structure for providing information to or receiving/providing information from a user, including network interface communications.

In the preceding description, for purposes of explanation, numerous details are set forth in order to provide a thorough understanding of the embodiments. However, it will be apparent to one skilled in the art that these specific details are not required. In other instances, well-known electrical structures and circuits are shown in block diagram form in order not to obscure the understanding. For example, specific details are not provided as to whether the embodiments described herein are implemented as a software routine, hardware circuit, firmware, or a combination thereof.

Embodiments of the disclosure can be represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor or other suitable processing device, and can interface with circuitry to perform the described tasks.

The above-described embodiments are intended to be examples only. Alterations, modifications and variations can be effected to the particular embodiments by those of skill in the art. The scope of the claims should not be limited by the particular embodiments set forth herein, but should be construed in a manner consistent with the specification as a whole.

1. A method comprising:
transmitting higher-layer signalling to configure a plurality of control resource sets (CORESETs) for a bandwidth part and to configure a plurality search space sets for the bandwidth part;
transmitting signalling to activate or deactivate at least one but not all of the configured plurality of CORESETs within the bandwidth; and
transmitting at least one control channel message using at least one activated CORESET.

2. The method of claim 1 wherein transmitting signalling to activate or deactivate at least one but not all of the configured plurality of CORESETs comprises transmitting a bandwidth part identifier identifying the active bandwidth part for which the at least one but not all of the configured plurality of CORESETs is being activated or deactivated.

3. The method of claim 1 wherein transmitting higher-layer signalling to configure a plurality of control resource sets (CORESETs) and to configure a plurality search space sets comprises:
transmitting radio resource control (RRC) signalling.

4. The method of claim 1 wherein transmitting signalling to activate or deactivate at least one but not all of the configured plurality of CORESETs comprises one of:
transmitting a media access control-control entity (MAC-CE);
transmitting a downlink control information (DCI);
transmitting RRC signalling.

5. The method of claim 1 wherein:
the signalling to configure a plurality of control resource sets (CORESETs) and to configure a plurality search space sets configures each search space set in association with a respective one of the configured plurality of control resource sets;
transmitting signalling to activate or deactivate at least one but not all of the configured plurality of CORESETs comprises transmitting signalling to explicitly activate or deactivate the at least one search space set, activation or deactivation of a search space set implicitly activating or deactivating the associated CORESET.

6. The method of claim 5 wherein transmitting signalling to explicitly activate or deactivate the at least one of the configured plurality of search space sets comprises transmitting a message containing a respective field for each of the plurality of search space sets.

7. The method of claim 6 wherein transmitting a respective field for each of at the one or more search spaces comprises transmitting a bitmap with a respective bit for each configured search space set.

8. The method of claim 1 wherein:
the signalling to configure a plurality of control resource sets (CORESETs) and to configure a plurality search space sets configures each search space set in association with a respective one of the configured plurality of CORESETs, such that for each CORESET there is at least one associated search space set; and
transmitting signalling to activate or deactivate at least one but not all of the configured plurality of CORESETs comprises transmitting signalling to explicitly activate or deactivate the at least one but not all of the configured CORESETs, activation or deactivation of a CORESET implicitly activating or deactivating the at least one search space set associated with the CORESET.

9. The method of claim 8 wherein transmitting signalling to explicitly activate or deactivate the at least one of the configured CORESETs comprises transmitting a respective field for each configured CORESETs.

10. The method of claim 8 wherein transmitting a respective field for each of the plurality of CORESETs comprises transmitting a bitmap with a respective bit for each configured CORESET.

11. The method of claim 1 wherein:
transmitting signalling to activate or deactivate at least one but not all of the configured plurality of CORESETs comprises transmitting signalling to explicitly activate or deactivate at least one CORESET-search space set link, each CORESET-search space set link consisting of one CORESET and one search space set.

12. The method of claim 11 wherein transmitting signalling to explicitly activate or deactivate at least one CORESET-search space set link comprises transmitting a respective field for each of a plurality of possible CORESET-search space set links.

13. The method of claim 11 wherein transmitting a respective field for each of a plurality of possible CORESET-search space set links comprises transmitting a bitmap with a respective bit for each possible CORESET-search space set link.

14. The method of claim 1 further comprising:
performing said transmitting higher-layer signalling to configure a plurality of control resource sets (CORESETs) and to configure a plurality search space sets for each of a plurality of configurations;
transmitting signalling to explicitly activate or deactivate one of the plurality of configurations;
wherein said signalling to activate or deactivate at least one but not all of the configured plurality of CORESETs is in respect of the activated configuration.

15. The method of claim 14 wherein transmitting signalling to explicitly activate or deactivate one of the plurality of configurations comprises transmitting a respective field for each of the plurality of configurations.

16. The method of claim 15 wherein transmitting a respective field for each of the plurality of configurations comprises transmitting a bitmap with a respective bit for of the plurality of configurations.

17. A base station comprising:
a processor; and
a non-transitory computer readable storage medium storing programming for execution by the processor, the programming including instructions to:
transmit higher-layer signalling to configure a plurality of control resource sets (CORESETs) for a bandwidth part and to configure a plurality search space sets for the bandwidth part;
transmit signalling to activate or deactivate at least one but not all of the configured plurality of CORESETs within the bandwidth; and
transmit at least one control channel message using at least one activated CORESET.

18. The base station of claim 17 wherein the instructions to transmit signalling to activate or deactivate at least one but not all of the configured plurality of CORESETs comprise instructions to transmit a bandwidth part identifier identifying the active bandwidth part for which the at least one but not all of the configured plurality of CORESETs is being activated or deactivated.

19. The base station of claim 17 wherein the instructions to transmit higher-layer signalling to configure a plurality of control resource sets (CORESETs) and to configure a plurality search space sets comprise instructions to:
transmit radio resource control (RRC) signalling.

20. The base station of claim 17 wherein the instructions to transmit signalling to activate or deactivate at least one but not all of the configured plurality of CORESETs comprises one of:
instructions to transmit a media access control-control entity (MAC-CE);
instructions to transmit a downlink control information (DCI);
instructions to transmit RRC signalling.

21. The base station of claim 17 wherein:
the signalling to configure a plurality of control resource sets (CORESETs) and to configure a plurality search space sets configures each search space set in association with a respective one of the configured plurality of control resource sets;
the instructions to transmit signalling to activate or deactivate at least one but not all of the configured plurality of CORESETs comprises instructions to transmit signalling to explicitly activate or deactivate the at least one search space set, activation or deactivation of a search space set implicitly activating or deactivating the associated CORESET.

22. The base station of claim 17 wherein:
the signalling to configure a plurality of control resource sets (CORESETs) and to configure a plurality search space sets configures each search space set in association with a respective one of the configured plurality of CORESETs, such that for each CORESET there is at least one associated search space set; and
the instructions to transmit signalling to activate or deactivate at least one but not all of the configured plurality of CORESETs comprise instructions to transmit signalling to explicitly activate or deactivate the at least one but not all of the configured CORESETs, activation or deactivation of a CORESET implicitly activating or deactivating the at least one search space set associated with the CORESET.

23. The base station of claim 17 wherein:
the instructions to transmit signalling to activate or deactivate at least one but not all of the configured plurality of CORESETs comprises instructions to transmit signalling to explicitly activate or deactivate at least one CORESET-search space set link, each CORESET-search space set link consisting of one CORESET and one search space set.

24. The base station of claim 17 further comprising:
instructions to performing said transmitting higher-layer signalling to configure a plurality of control resource sets (CORESETs) and to configure a plurality search space sets for each of a plurality of configurations;
instructions to transmit signalling to explicitly activate or deactivate one of the plurality of configurations;
wherein said signalling to activate or deactivate at least one but not all of the configured plurality of CORESETs is in respect of the activated configuration.
